(19) United States
(12) Patent Application Publication
(10) Pub. No.: US 2006/0269326 A1
(43) Pub. Date: Nov. 30, 2006

(54) Dicorotron having a shield insert

(75) Inventors: Michael A. Lodato, Rochester, NY (US); Leon G. Poplawski, Webster, NY (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 11/135,991

(22) Filed: May 24, 2005

(51) Int. Cl. G03G 15/02

(52) U.S. Cl. 399/172

(57) ABSTRACT

A corona generating device with a removable shield including: a housing; the housing including spaced generally parallel side panels defining a cavity therebetween; and a shield insert having a generally U-shaped cross-sectional configuration including a pair of spaced sides with a lower portion therebetween and being insertable into and removable from the cavity and a top of surface of the lower portion of the shield insert being a conductive shield and a bottom surface of the lower portion of the shield insert forming an evacuation chamber between the housing and the shield insert.

This invention relates generally to a corona generating device, and more particularly concerns a dicorotron having a removable shield insert.

In a typical electrophotographic printing process, a photoconductive member is charged to a substantially uniform potential so as to sensitize the surface thereof. The charged portion of the photoconductive member is exposed to a light image of an original document being reproduced.

Exposure of the charged photoconductive member selectively dissipates the charges thereon in the irradiated areas. This records an electrostatic latent image on the photoconductive member corresponding to the informational areas contained within the original document. After the electrostatic latent image is recorded on the photoconductive member, the latent image is developed by bringing a developer material into contact therewith. Generally, the developer material comprises toner particles adhering triboelectrically to carrier granules. The toner particles are attracted from the carrier granules to the latent image forming a toner powder image on the photoconductive member. The toner powder image is then transferred from the photoconductive member to a copy sheet.

The toner particles are heated to permanently affix the powder image to the copy sheet.

In printing machines such as those described above, corona devices perform a variety of other functions in the printing process. For example, corona devices aid the transfer of the developed toner image from a photoconductive member to a transfer member. Likewise, corona devices aid the conditioning of the photoconductive member prior to, during, and after deposition of developer material thereon to improve the quality of the electrophotographic copy produced thereby. Both direct current (DC) and alternating current (AC) type corona devices are used to perform these functions.

One form of a corona charging device comprises a corona electrode in the form of an elongated wire connected by way of an insulated cable to a high voltage AC/DC power supply. The corona wire is partially surrounded by a conductive shield. The photoconductive member is spaced from the corona wire on the side opposite the shield. An AC voltage may be applied to the corona wire and at the same time, a DC bias voltage is applied to the shield to regulate ion flow from the corona wire to the photoconductive member being charged.

Another form of a corona charging device is pin corotrons and scorotrons. The pin corotron comprises an array of pins integrally formed from a sheet metal member that is connected by a high voltage cable to a high power supply. The sheet metal member is supported between insulated end blocks and mounted within a conductive shield. The photoconductive member to be charged is spaced from the sheet metal member on the opposite side of the shield. The scorotron is similar to the pin corotron, but is additionally provided with a screen or control grid disposed between the coronode and the photoconductive member. The screen is held at a lower potential approximating the charge level to be placed on the photoconductive member. The scorotron provides for more uniform charging and prevents overcharging.

Still other forms of corona charging devices include a dicorotron. The dicorotron comprises a coronode having a conductive wire that is coated with an electrically insulating material. When AC power is applied to the coronode by way of an insulated cable, substantially no net DC current flows in the wire due to the thickness of the insulating material. Thus, when the conductive shield forming a part of dicorotron and the photoconductive member passing thereunder at the same potential, no current flows to the photoconductive member or the conductive shield. However, when the shield and photoconductive member are at different potentials, for example, when there is a copy sheet attached to the photoconductive member to which toner images have been electrostatically transferred thereto, an electrostatic field is established between the shield and the photoconductive member which causes current to flow from the shield to the ground.

Prior designs of shields, such as disclosed in U.S. Pat. No. ______, have utilized a DAG coating on the interior of the dicorotron housing or shell combined with an independent tubular shield that also serves as an evacuation duct. The system acts to eliminate image degradation resulting from effluent contaminants generated by the charging wire. The DAG coating molecularly interacts with the effluents to prevent formation of destructive by-products, while the tubular shield permits elimination of the airborne contaminants. Each device is connected to a filter/blower unit that extracts the contaminants through slots in the shield and purges them from the system.

In a high speed color machine capable of producing 100 or more images per minute, such as the IGEN3® manufactured by Xerox, requires a charging device capable of delivering uniform charging performance during high speed imaging. Further, there is needed a charging device having a shield which is robust and has a low UMC.

There is provided a shield which simplifies the shield construction by forming Titanium alloy sheet metal element into a shield that attaches semi-permanently to the plastic dicorotron housing or shell and eliminates the need for the DAG coating while preserving the evacuation function of the original design.

There is provided a corona generating device with a removable shield including: a housing; the housing including spaced generally parallel side panels defining a cavity therebetween; and a shield insert having a generally U-shaped cross-sectional configuration including a pair of spaced sides with a lower portion therebetween and being insertable into and removable from the cavity and a top of surface of the lower portion of the shield insert being a conductive shield and a bottom surface of the lower portion of the shield insert forming an evacuation chamber between the housing and the shield insert.

Other aspects of the present invention will become apparent as the following description proceeds and upon reference to the drawings, in which:

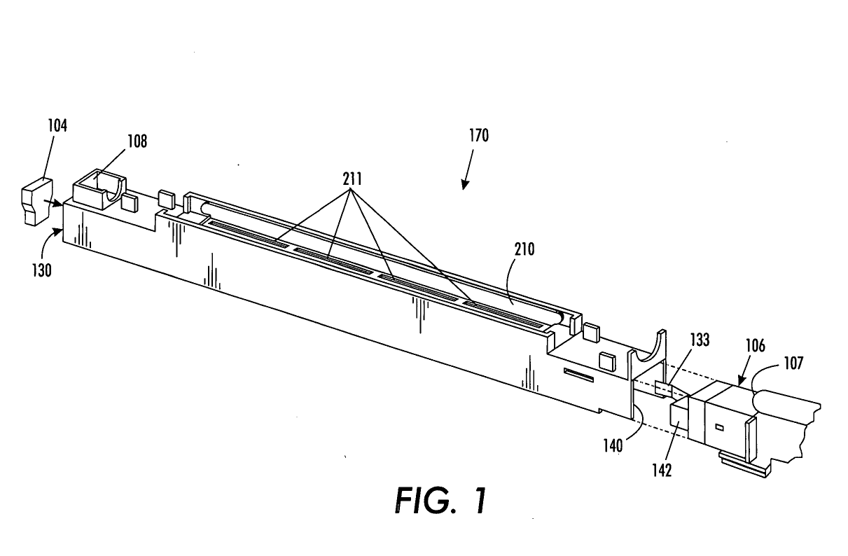

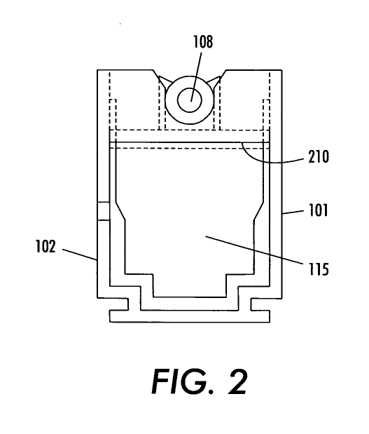

FIGS. 1 and 2 are illustrated configurations of a discorotron useful in the printer apparatus;

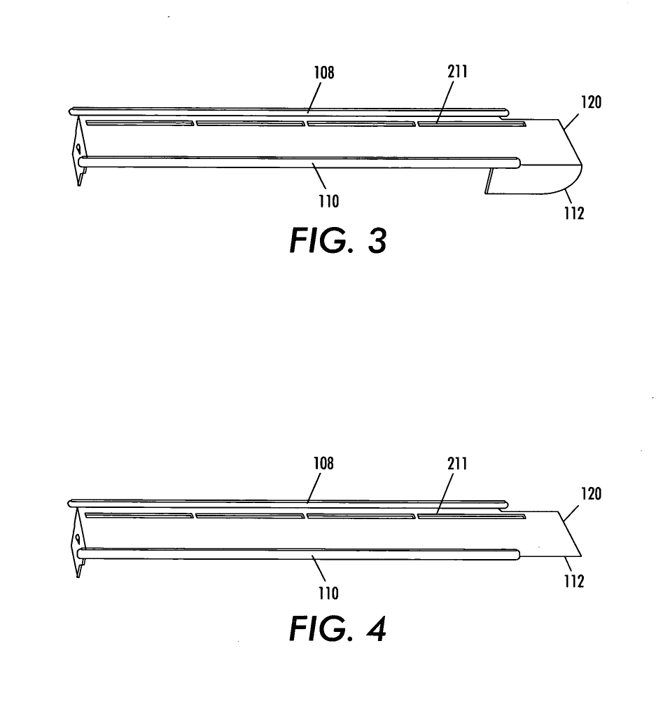

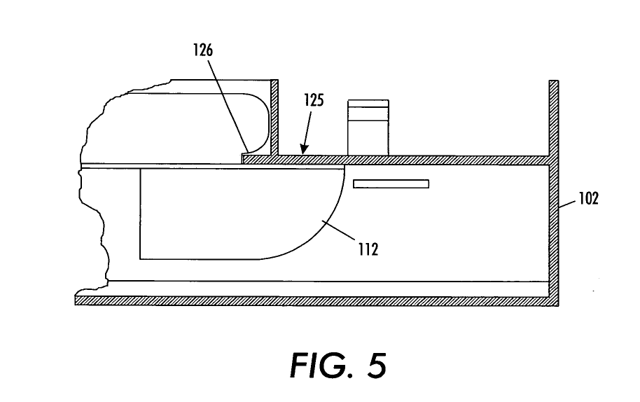

FIGS. 3-5 are illustrated configurations of shield inserts; and

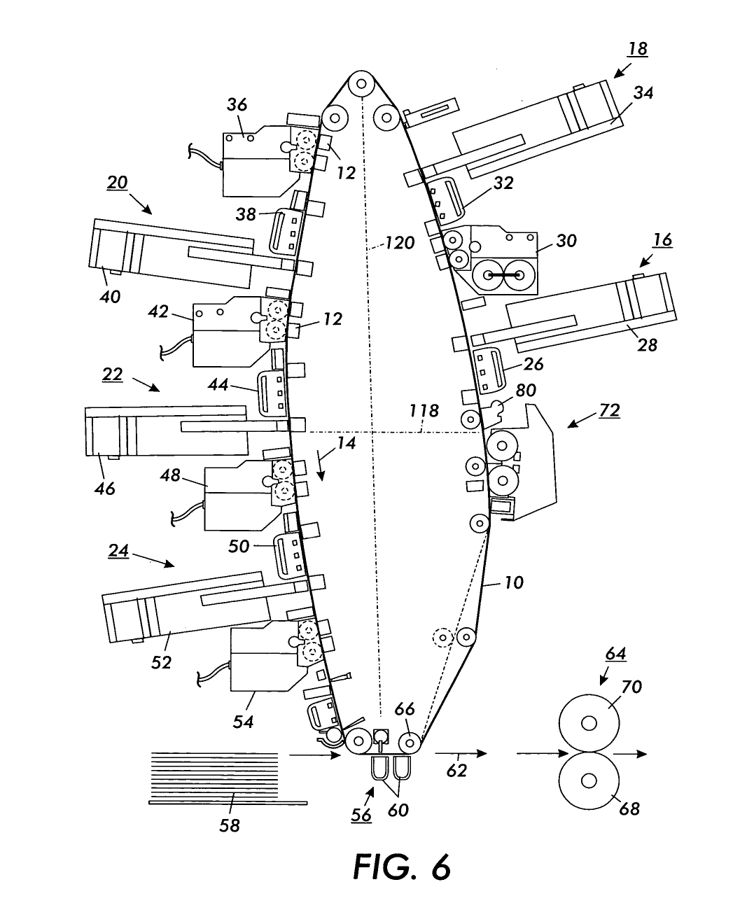

FIG. 6 is a schematic elevational view depicting an illustrative high speed color electrophotographic printing machine incorporating the apparatus of the present invention therein.

While the present invention will hereinafter be described in connection with a preferred embodiment, it will be understood that it is not intended to limit the invention to that embodiment. On the contrary, it is intended to cover all alternatives, modifications and equivalents as may be included within the spirit and scope of the invention as defined by the appended claims.

For a general understanding of the features of the present invention, reference is made to the drawings. In the drawings, like reference numerals have been used throughout to designate identical elements.

Referring initially to FIG. 6, there is shown a high speed color electrophotographic printing machine, capable of producing over 100 images per minute, such as Xerox's IGEN3®, having the charging device of the present invention therein. Referring now to the drawing, there is shown a single pass multi-color printing machine. This printing machine employs a photoconductive belt 10, supported by a plurality of rollers or bars. Photoconductive belt 10 is arranged in a vertical orientation. Photoconductive belt 10 advances in the direction of arrow 14 to move successive portions of the external surface of photoconductive belt 10 sequentially beneath the various processing stations disposed about the path of movement thereof. The photoconductive belt has a major axis 120 and a minor axis 118. The major and minor axes are perpendicular to one another. Photoconductive belt 10 is elliptically shaped. The major axis 120 is substantially parallel to the gravitational vector and arranged in a substantially vertical orientation. The minor axis 118 is substantially perpendicular to the gravitational vector and arranged in a substantially horizontal direction. The printing machine architecture includes five image recording stations indicated generally by the reference numerals 16, 18, 20, 22, and 24, respectively. Initially, photoconductive belt 10 passes through image recording station 16. Image recording station 16 includes a charging device and an exposure device. The charging device includes including a corona generator 26 that charges the exterior surface of photoconductive belt 10 to a relatively high, substantially uniform potential. After the exterior surface of photoconductive belt 10 is charged, the charged portion thereof advances to the exposure device. The exposure device includes a raster output scanner (ROS) 28, which illuminates the charged portion of the exterior surface of photoconductive belt 10 to record a first electrostatic latent image thereon. Alternatively, a light emitting diode (LED) may be used.

This first electrostatic latent image is developed by developer unit 30. Developer unit 30 deposits toner particles of a selected color on the first electrostatic latent image. After the highlight toner image has been developed on the exterior surface of photoconductive belt 10, belt 10 continues to advance in the direction of arrow 14 to image recording station 18.

Image recording station 18 includes a recharging device and an exposure device. The charging device includes a corona generator 32 which recharges the exterior surface of photoconductive belt 10 to a relatively high, substantially uniform potential. The exposure device includes a ROS 34 which illuminates the charged portion of the exterior surface of photoconductive belt 10 selectively to record a second electrostatic latent image thereon. This second electrostatic latent image corresponds to the regions to be developed with magenta toner particles. This second electrostatic latent image is now advanced to the next successive developer unit 36.

Developer unit 36 deposits magenta toner particles on the electrostatic latent image. In this way, a magenta toner powder image is formed on the exterior surface of photoconductive belt 10. After the magenta toner powder image has been developed on the exterior surface of photoconductive belt 10, photoconductive belt 10 continues to advance in the direction of arrow 14 to image recording station 20.

Image recording station 20 includes a charging device and an exposure device. The charging device includes corona generator 38, which recharges the photoconductive surface to a relatively high, substantially uniform potential. The exposure device includes ROS 40 which illuminates the charged portion of the exterior surface of photoconductive belt 10 to selectively dissipate the charge thereon to record a third electrostatic latent image corresponding to the regions to be developed with yellow toner particles. This third electrostatic latent image is now advanced to the next successive developer unit 42.

Developer unit 42 deposits yellow toner particles on the exterior surface of photoconductive belt 10 to form a yellow toner powder image thereon. After the third electrostatic latent image has been developed with yellow toner, photoconductive belt 10 advances in the direction of arrow 14 to the next image recording station 22.

Image recording station 22 includes a charging device and an exposure device. The charging device includes a corona generator 44, which charges the exterior surface of photoconductive belt 10 to a relatively high, substantially uniform potential. The exposure device includes ROS 46, which illuminates the charged portion of the exterior surface of photoconductive belt 10 to selectively dissipate the charge on the exterior surface of photoconductive belt 10 to record a fourth electrostatic latent image for development with cyan toner particles. After the fourth electrostatic latent image is recorded on the exterior surface of photoconductive belt 10, photoconductive belt 10 advances this electrostatic latent image to the magenta developer unit 48.

Cyan developer unit 48 deposits magenta toner particles on the fourth electrostatic latent image. These toner particles may be partially in superimposed registration with the previously formed yellow powder image. After the cyan toner powder image is formed on the exterior surface of photoconductive belt 10, photoconductive belt 10 advances to the next image recording station 24.

Image recording station 24 includes a charging device and an exposure device. The charging device includes corona generator 50 which charges the exterior surface of photoconductive belt 10 to a relatively high, substantially uniform potential. The exposure device includes ROS 54, which illuminates the charged portion of the exterior surface of photoconductive belt 10 to selectively discharge those portions of the charged exterior surface of photoconductive belt 10 which are to be developed with black toner particles. The fifth electrostatic latent image, to be developed with black toner particles, is advanced to black developer unit 54.

At black developer unit 54, black toner particles are deposited on the exterior surface of photoconductive belt 10. These black toner particles form a black toner powder image which may be partially or totally in superimposed registration with the previously formed yellow and magenta toner powder images. In this way, a multi-color toner powder image is formed on the exterior surface of photoconductive belt 10. Thereafter, photoconductive belt 10 advances the multi-color toner powder image to a transfer station, indicated generally by the reference numeral 56.

At transfer station 56, a receiving medium, i.e., paper, is advanced from stack 58 by sheet feeders and guided to transfer station 56. At transfer station 56, a corona generating device 60 sprays ions onto the backside of the paper. This attracts the developed multi-color toner image from the exterior surface of photoconductive belt 10 to the sheet of paper. Stripping assist roller 66 contacts the interior surface of photoconductive belt 10 and provides a sufficiently sharp bend thereat so that the beam strength of the advancing paper strips from photoconductive belt 10. A vacuum transport moves the sheet of paper in the direction of arrow 62 to fusing station 64.

Fusing station 64 includes a heated fuser roller 70 and a back-up roller 68. The back-up roller 68 is resiliently urged into engagement with the fuser roller 70 to form a nip through which the sheet of paper passes. In the fusing operation, the toner particles coalesce with one another and bond to the sheet in image configuration, forming a multi-color image thereon. After fusing, the finished sheet is discharged to a finishing station where the sheets are compiled and formed into sets which may be bound to one another. These sets are then advanced to a catch tray for subsequent removal therefrom by the printing machine operator.

One skilled in the art will appreciate that while the multi-color developed image has been disclosed as being transferred to paper, it may be transferred to an intermediate member, such as a belt or drum, and then subsequently transferred and fused to the paper. Furthermore, while toner powder images and toner particles have been disclosed herein, one skilled in the art will appreciate that a liquid developer material employing toner particles in a liquid carrier may also be used.

Invariably, after the multi-color toner powder image has been transferred to the sheet of paper, residual toner particles remain adhering to the exterior surface of photoconductive belt 10. The photoconductive belt 10 moves over isolation roller 78 which isolates the cleaning operation at cleaning station 72. At cleaning station 72, the residual toner particles are removed from photoconductive belt 10. Photoconductive belt 10 then moves under spots blade 80 to also remove toner particles therefrom.

Turning now to FIGS. 1-5 inclusive, there is illustrated configurations of dicorotrons useful in the printer apparatus of FIG. 6, charging devices 26, 32, 38, 44 and 50 are identical to dicorotron 170.

Dicorotron 170 includes housing 102 having a generally U-shaped cross-sectional configuration having parallel side panels defining a cavity therebetween that is composed of an insulated material such as plastic. Shield insert 210 is positioned on the bottom of housing 102 and is powered by power supply (not shown). A dielectric coated coronode wire located at a predetermined distance from the shield and is powered by power supply (not shown). The preferred coating on the wire is a glass coating.

Shield insert has a generally U-shaped cross-sectional configuration which including a pair of spaced sides with a lower portion therebetween. Shield is insertable and removable from the cavity form by the U-shaped cross-sectional configuration. In operation, the top surface of the lower portion of shield insert is a conductive shield and a bottom surface of the lower portion of the shield insert forms an evacuation chamber between the housing and the shield insert.

Lower portion of shield insert includes evacuation slots 211 defined therein which allows airborne contaminants to move to the evacuation chamber when a vacuum is applied to evacuation chamber 115.

End receptacle 106 is positioned at on end of housing, and provides an electrical biasing contact with shield insert in which contact 133 contact tab portion 112 of shield 210. End receptacle includes port 142, connected to evacuation chamber 115 which removes airborne contaminants from evacuation chamber 115 when a vacuum is applied to port.

Portion 107 of end receptacle 106 and end portion 108 hold the coronode wire at a predefined tension. End receptacle 106 also provides a contact point for biasing coronode wire. End block 104 enclosing end 150 of evacuation chamber 115 and receptacle encloses end 140 of evacuation chamber 118.

In an embodiment of shield 210 illustrated in FIG. 3, shield includes a portion of the pair of spaced sides having notched portion 112 which engages lip portion 125 of housing 102 to retain the shield within housing 102. In another embodiment of shield 210 illustrated in FIG. 4, shield includes a portion of the lower having a notched portion which engages a lip portion of the housing to retain the shield within housing 102. Notch portion 112 provides an electrical contact to receptacle via contact 133. Side rails 110 and 108 also assist in holding the shield in place within the housing.

An advantageous feature is the shield may be fabricated from Titanium alloy sheet stock through conventional metal forming processes, including punch/laser cutting and forming operations, to the form illustrated as shown in FIGS. 3 and 4. The shape of the insert covers the interior surfaces of the housing 102 surrounding the coronode wire with the Titanium insert which eliminates the need for the DAG coating. This increases the life of the dicorotron since the Titanium surfaces may be cleaned of residual contaminants, unlike the DAG material which cannot be cleaned and necessitates periodic replacement of the device.

Another advantageous feature of the present disclosure is that the device is assembled by installation of the insert into a standard non-DAG coated housing 102. The inboard end is placed into the shell first, capturing the edge of the wire insulator-mounting pad in the Positioning Notch. The insert is then pivoted downward and further into the housing 102, fully engaging the positioning notch and allowing the end tab to enter and fully seat in the interior of the housing 102. The insert is securely retained in place by the capture features of the positioning notch and the integral detent feature on the end tab, but is removable for cleaning.

The shield insert and housing create an evacuation chamber terminated by fitting an elastomer plug into the end tab of the device. The elastomer plug acts as a sealing gasket at that end while the connector receptacle defines the opposite end of the chamber. The evacuation chamber draws airborne contaminant from the region of the charging wire through the slot running the length of the insert. Collected contaminants are then ducted through the Connector to the filter module for processing and removal from the machine. The shield insert retains the existing Xerographic Control System function by operating as a collector for the electrical current induced by the charging wire. The Xerographic Control software monitors this current feedback signal to adjust the system for optimum performance. In recapitulation, shield insert is a u-shaped Titanium alloy baffle that functions to control the contaminant by-products of the wire corona in place of the current tubular shield and DAG coating. The device offers three principal functions. 1) It covers the interior sidewalls of the dicorotron shell in place of the DAG coating to suppress contaminant formation. 2) It creates an evacuation chamber for the purpose of collection and removal of charging wire contaminants. 3) It functions as a component of the xerographic control system by reacting to the electrical influence of the charging wire and generating a feedback signal to the control system. The insert is fitted into the plastic dicorotron shell as a semi-permanent component that can be removed for cleaning if necessary.

It is, therefore, apparent that there has been provided in accordance with the present invention, a charging apparatus which fully satisfies the aims and advantages hereinbefore set forth. While this invention has been described in conjunction with a specific embodiment thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. A corona generating device with a removable shield comprising,
a housing; said housing including spaced generally parallel side panels defining a cavity therebetween; and
a shield insert having a generally U-shaped cross-sectional configuration including a pair of spaced sides with a lower portion therebetween and being insertable into and removable from said cavity and a top surface of said lower portion of said shield insert being a conductive shield and a bottom surface of said lower portion of said shield insert forming an evacuation chamber between said housing and said shield insert.

2. A corona generating device of claim 1, wherein said lower portion of said shield insert includes evacuation slots which allows airborne contaminants to move to said evacuation chamber when a vacuum is applied to said evacuation chamber.

3. A corona generating device of claim 2, further comprising an end receptacle, positioned at on end of said housing, for providing electrical biasing contact with said shield.

4. A corona generating device of claim 3, wherein said end receptacle includes an air port, connected to said evacuation chamber, for removing airborne contaminants from said evacuation chamber.

5. A corona generating device of claim 3, wherein said end receptacle further includes means for holding a corona generating electrode and means for biasing said corona generating electrode.

6. A corona generating device of claim 2, further comprising a plug for enclosing one end of said evacuation chamber and wherein said end receptacle encloses said other end.

7. A corona generating device of claim 2, further comprising means for retaining said removable shield means in operative position relative to said housing.

8. A corona generating device of claim 7, wherein said retaining means includes a portion of said pair of spaced sides having a notched portion which engages a lip portion of said housing.

9. A corona generating device of claim 7, wherein said retaining means includes a portion of said lower having a notched portion which engages a lip portion on said housing.

10. A corona generating device of claim 7, wherein said retaining portion provides an electrical contact to said receptacle.

11. A printing machine having a corona generating device, comprising:
a housing; said housing including spaced generally parallel side panels defining a cavity therebetween; and
a shield insert having a generally U-shaped cross-sectional configuration including a pair of spaced sides with a lower portion therebetween and being insertable into and removable from said cavity and a top surface of said lower portion of said shield insert being a conductive shield and a bottom surface of said lower portion of said shield insert forming an evacuation chamber between said housing and said shield insert.

12. A printing machine having a corona generating device of claim 11, wherein said lower portion of said shield insert includes evacuation slots which allows airborne contaminants to move to said evacuation chamber when a vacuum is applied to said evacuation chamber.

13. A printing machine having a corona generating device of claim 12, further comprising an end receptacle, positioned at on end of said housing, for providing electrical biasing contact with said shield.

14. A printing machine having a corona generating device of claim 13, wherein said end receptacle includes an air port, connected to said evacuation chamber, for removing airborne contaminants from said evacuation chamber.

15. A printing machine having a corona generating device of claim 13, wherein said end receptacle further includes means for holding a corona generating electrode and means for biasing said corona generating electrode.

16. A printing machine having a corona generating device of claim 12, further comprising a plug for enclosing one end of said evacuation chamber and wherein said end receptacle encloses said other end.

17. A printing machine having a corona generating device of claim 12, further comprising means for retaining said removable shield means in operative position relative to said housing.

18. A printing machine having a corona generating device of claim 17, wherein said retaining means includes a portion of said pair of spaced sides having a notched portion which engages a lip portion of said housing.

19. A printing machine having a corona generating device of claim 17, wherein said retaining means includes a portion of said lower having a notched portion which engages a lip portion on said housing.

20. A printing machine having a corona generating device of claim 17, wherein said retaining portion provides an electrical contact to said receptacle.
